(19) United States
(12) Patent Application Publication
(10) Pub. No.: US 2021/0103706 A1
(43) Pub. Date: Apr. 8, 2021

(54) KNOWLEDGE GRAPH AND ALIGNMENT WITH UNCERTAINTY EMBEDDING

(71) Applicant: NEC Laboratories America, Inc., Princeton, NJ (US)

(72) Inventors: Wenchao Yu, Plainsboro, NJ (US); Bo Zong, West Windsor, NJ (US); Wei Cheng, Princeton Junction, NJ (US); Haifeng Chen, West Windsor, NJ (US); Xiusi Chen, Los Angeles, CA (US)

(21) Appl. No.: 17/060,850

(22) Filed: Oct. 1, 2020

Related U.S. Application Data
(60) Provisional application No. 62/910,855, filed on Oct. 4, 2019.

(51) Int. Cl. G06F 40/58; G06F 40/44; G06N 5/02; G06N 5/04; G06N 3/04

(52) U.S. Cl. CPC G06F 40/58; G06F 40/44; G06N 3/0427; G06N 5/04; G06N 5/02

(57) ABSTRACT

Methods and systems for performing a knowledge graph task include aligning multiple knowledge graphs and performing a knowledge graph task using the aligned multiple knowledge graphs. Aligning the multiple knowledge graphs includes updating entity representations based on representations of neighboring entities within each knowledge graph, updating entity representations based on representations of entities from different knowledge graphs, and learning machine learning model parameters to align the multiple knowledge graphs, based on the updated entity representations.

### RELATED APPLICATION INFORMATION

This application claims priority to U.S. Patent Application Ser. No. 62/910,855, filed on Oct. 4, 2019, incorporated herein by reference entirety.

### BACKGROUND

### Technical Field

The present invention relates to knowledge graphs, and, more particularly, to combining information from diverse knowledge graphs into a single representation.

### Description of the Related Art

Knowledge graphs are a flexible tool for encoding a wide variety of different kinds of information. As just one example, knowledge graphs can be used, for example, in natural language processing tasks, such as question answering systems, machine translation, and semantic searching. Different knowledge graphs may use, for example, incompatible symbol systems and name spaces, making it difficult to integrate the contents of knowledge graphs that come from different sources.

### SUMMARY

A method for performing a knowledge graph task includes aligning multiple knowledge graphs and performing a knowledge graph task using the aligned multiple knowledge graphs. Aligning the multiple knowledge graphs includes updating entity representations based on representations of neighboring entities within each knowledge graph, updating entity representations based on representations of entities from different knowledge graphs, and learning machine learning model parameters to align the multiple knowledge graphs, based on the updated entity representations.

A system for performing a knowledge graph task includes a hardware processor and a memory, configured to store a computer program product. When executed by the hardware processor, the computer program product implements graph alignment code that updates entity representations based on representations of neighboring entities within each knowledge graph of a set of multiple knowledge graphs, updates entity representations based on representations of entities from different knowledge graphs of the set of multiple knowledge graphs, and learns machine learning model parameters to align the knowledge graphs of the set of multiple knowledge graphs, based on the updated entity representations. The computer program product further implements knowledge graph task code that performs a knowledge graph task using the aligned knowledge graphs.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram illustrating the performance of a natural language task, such as a question answering system, using multiple aligned knowledge graphs, in accordance with an embodiment of the present invention;

FIG. 2 is a diagram of an exemplary knowledge graph, in accordance with an embodiment of the present invention;

FIG. 3 is a block/flow diagram of a method for aligning multiple different knowledge graphs, using intra-graph message passing and inter-graph message passing, in accordance with an embodiment of the present invention;

FIG. 4 is a block/flow diagram of a method for performing a knowledge graph task using multiple knowledge graphs, in accordance with an embodiment of the present invention;

FIG. 5 is a block diagram of a system for performing a knowledge graph task using multiple knowledge graphs, in accordance with an embodiment of the present invention;

FIG. 6 is a diagram of an exemplary high-level neural network, in accordance with an embodiment of the present invention; and

FIG. 7 is a diagram of an exemplary neural network architecture, in accordance with an embodiment of the present invention.

### DETAILED DESCRIPTION OF PREFERRED EMBODIMENTS

Embodiments of the present principles provide machine learning models that determine representations of the structure of input knowledge graphs, making it possible to align knowledge graphs that come from different sources. The aligned knowledge graphs can then be used to combine the graphs' respective knowledge bases, so that they can be used in tandem for any appropriate application. The process of alignment makes use of seed alignments, which help to maintain alignment between known-related entities, while other entities are moved with respect to one another.

Toward that end, the present principles provide an end-to-end framework that incorporates uncertainty embedding and message passing. Within each input knowledge graph, intra-graph messages are passed between entities to capture the graph structures and to make use of seed alignments. The seed alignments can be used as bridges for aligned seed entities to communicate and to synchronize their respective representations. The model thereby determines to what extent the representation of the seed entities are similar to one another.

Each entity may be embedded in a latent space. Rather than using a fixed-value point vector to represent an entity, a Gaussian distribution may be used to represent the uncertainty that may arise when different knowledge bases have inconsistent or conflicting information. This is a concern when, for example, the knowledge bases may be in different base languages, where similar words may have different uses or shades of meaning. The Gaussian distribution may incorporate variance statistics, such as a covariance Σ, as well as a mean value μ. The mean value may be used where a point vector value would otherwise be used, but even distributions with exactly the same mean value can still have distinct variances. This makes the two distributions distinguishable, and makes similar entities distinguishable, thereby improving performance of the knowledge graph application.

The knowledge graph representations may be learned using, e.g., a graph neural network (GNN) framework. In a GNN framework, aligned entities can be aligned using a semi-supervised approach, with a few aligned entities or relations as guidance. For example, a stochastic gradient descent approach can be used to determine alignment parameters, by minimizing a loss function on a training dataset.

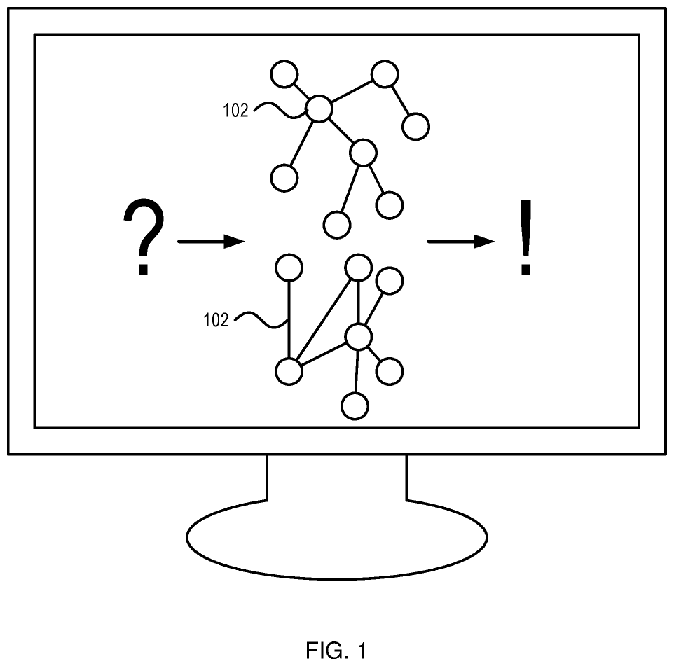

Referring now in detail to the figures in which like numerals represent the same or similar elements and initially to FIG. 1, a high-level system for performing a knowledge graph task is illustratively depicted in accordance with one embodiment of the present invention. In this example, a question-answer system is shown, where a question is posed, and a knowledge graph is used to determine an answer.

As shown, two separate knowledge graphs may be used, including a first graph 102 and a second graph 104. These graphs may be drawn from different sources and may have different formats for representing information, but generally include information that represents triplets (h, r, t), which indicate that the entity h has some relationship r with the entity t. The present embodiments may use multiple disparate knowledge graphs to perform a knowledge graph task, for example by aligning the knowledge graphs.

To accomplish this, the present embodiments may pass intra-graph messages within each separate knowledge graph to capture the graph structures. Seed alignments may be used to bridge aligned seed entities, to help synchronize representations. The present embodiments then learn to what extent the representations of seed entities are similar. From each entity's perspective, messages arrive from its neighbors, and are used to update its own representation.

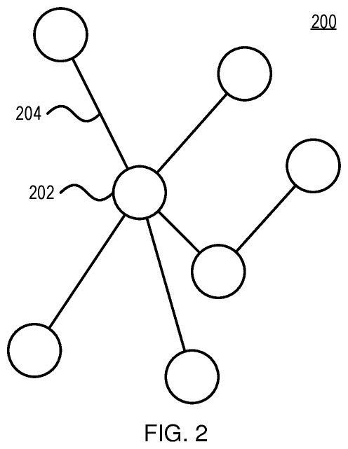

Referring now to FIG. 2, a diagram of a knowledge graph 200 is shown. The graph 200 may be made up of entity nodes 202, with edges 204 between them representing relationships. Thus, a relationship triplet may identify a first entity node 202, an edge 204, and a second entity node 202.

Knowledge graphs may encode facts and experiences in this manner, and may be used in a wide variety of tasks, such as natural language processing tasks. However, due to the complexity of real-world facts, it can be difficult to build a universal knowledge graph that can be adapted to every domain. Thus, knowledge graphs generally only cover limited domains. The present embodiments integrate multiple knowledge graphs together, for example from different domains, to form a unified knowledge graph.

Because different knowledge graphs may be built to respond to the needs of specific scenarios, they may not use a unified naming space that includes all of the variances of the surface names of entities and relations. This is apparent in the case of cross-language knowledge graph alignment, where similar concepts may have completely different names. To overcome the often incompatible symbol systems and name spaces of differing knowledge graphs, the present embodiments align entities and relations across the different graphs.

When aligning knowledge graphs, the present embodiments avoid the overconfidence in representation that can result from representing entities and relations as point vectors in a latent space. Due to the task-specificity that may apply to a given knowledge graph, there may be gaps in the information encoded by the knowledge graph, resulting in modeling uncertainty. When learning the representations of entities and relations, it can be difficult for point vectors to precisely model the subtle differences between very similar entities. The present embodiments therefore may use statistical distributions, such as a Gaussian embedding, to encode the uncertainty of each representation. Because the Gaussian distribution incorporates variance statistics, beyond just the mean, even distributions with exactly the same mean values can be distinguishable due to their respective uncertainties. Accounting for this uncertainty improves the accuracy of the knowledge graph task.

GNNs may be used to generate representations of knowledge graphs. A GNN is a type of neural network that deals with graph-structured data. A propagation model may be used, which enhances the features of an entity node in accordance with information from neighboring nodes. Multiple layers can be used in a GNN to further this propagation of information, with each layer acting as a filter that takes some graph structure-related matrices. One variant of a GNN is a graph convolutional network (GCN). In one example, the GNN may be expressed as:

GNN(A,H,W)=σ(AHW)

where A is an adjacency matrix of an input graph, H is an input latent representation, W is a set of trainable parameters of the model, and σ is a neural network activation function, such as the sigmoid function.

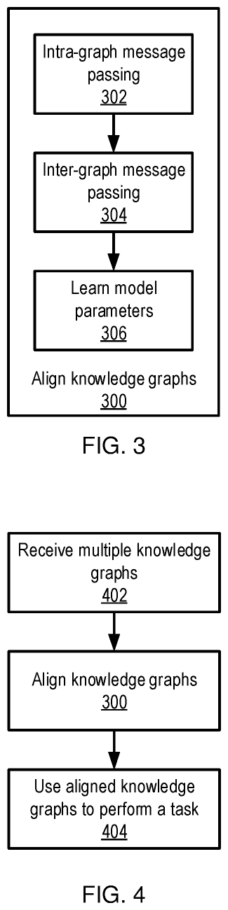

Referring now to FIG. 3, a method is shown for aligning knowledge graphs by training a model that forms representations of the entities of knowledge graphs. Block 302 uses intra-graph message passing to collect structural information of an input knowledge graph. Within the graph, each entity collects “messages,” which are made up of representations, from its neighbors, and updates its own representation. Any appropriate initial embedding for the graphs may be used. During a learning process, an adjacency matrix is encoded into a GNN. The entity representations can then be propagated along the structure of the knowledge graphs, with each node broadcasting its representation to its neighbors. The adjacency matrix preserves the overall structure while the model is being learned.

The message from a node j to a node i may be expressed as:

$$\begin{matrix}{m}_{j \to i} = {f}_{message} ( {h}_{i}^{( t )} , {h}_{j}^{( t )} , {h}_{{e}_{j \to i}} ) , ∀ ( i , j ) ∈ {E}_{1} ⋃ {E}_{2} \\ = AGGREGATE ( \{ CONCAT ( {h}_{{e}_{j \to i}}^{( t )} , {h}_{j}^{( t )} ) , ∀ j ∈ 𝒩 ( i ) \} )\end{matrix}$$

where i and j are entities from the same knowledge graph, h stands for the Gaussian embeddings (including a concatenation of a Σ matrix and a μ matrix, representing the deviation and mean), [symbol] (⋅) is the neighbors of a node in the knowledge graph, and m is a representation sent from one entity to its neighbors in the same knowledge graph. Based on this message m, the neighbors update their representations. Each node receives messages from its own neighbors, and updates its own representation. The representation using h captures uncertainty in the word embedding. Block 302 aggregates the representations of all of each node's neighbors. The aggregate function can be defined as a maximum function, mean function, pooling function, LSTM function, or any other appropriate aggregation function.

Block 304 performs inter-graph message passing between different input knowledge graphs. Using a graph attention framework, attentional edges between seed entities can be constructed, to act as seed alignments. Given the seed entities residing in two different knowledge graphs, a larger knowledge graph that includes all of the entities of both graphs can be created, with only the attentional edges acting as seed alignments. Messages are passed in the form of entity representations, but the attention coefficients, which are trainable parameters, can decide the importance of the messages from a counterpart and from first-order neighbors. The inter-graph messages can be expressed as:

$$\begin{matrix}{u}_{j \to i} = {f}_{match} ( {h}_{i}^{( t )} , {h}_{j}^{( t )} ) , ∀ i ∈ {V}_{1} , j ∈ {V}_{2} or i ∈ {V}_{2} , j ∈ {V}_{1} \\ = {\sum }_{j ∈ {𝒩}_{i}} {α}_{ij} {Wh}_{j}^{( t )} \end{matrix}$$

where i and j are nodes from two different knowledge graphs, and where:

$${α}_{ij} = \frac{{e}^{L e a k y R e L U ( {a}^{T} [ {W}_{1} {h}_{i} \vert \vert {W}_{1} {h}_{j} ] )}}{{Σ}_{k ∈ {𝒩}_{i}} {e}^{L e a k y R e L U ( {a}^{T} [ {W}_{1} {h}_{i} \vert \vert {W}_{1} {h}_{k} ] )}}$$

parameterized by W₁ and a, where LeakeReLU is an activation function. The function ƒ_{match} is an aggregation function for cross-graph messages, and may be implemented as an attention function. The dynamic weights of the cross-graph aggregation function measure the importance of messages passed between counterparts and first-order neighbors. The term u plays a similar role to that of m, described above, as the representation sent from one entity to its neighbors in a different knowledge graph. For the representations of entities to be in the same latent space, edges can be built between previously aligned pairs across the two knowledge graphs. The representations can then be propagated between them, to bring them closer together.

The h matrices described above may be updated by computing each layer of a graph neural network. For example, hᵢ₊₁=ƒ (AhᵢW), where A is the adjacency matrix and W is a trainable parameter.

Block 306 uses a loss function to learn the parameters of the entity embedding model. As a general matter, nodes belonging to the one-hop neighborhood of an entity may be placed closer to that entity than the nodes in the entity's two-hop neighborhood. The two-hop neighbors may then, in turn, be positioned closer to the entity than the nodes in the entity's three-hop neighborhood, and so on, up to K hops. One part of the loss function can then be expressed according to structural factors

[symbol]

_{structure}=Δ(hᵢ,hₖ_{ᵢ})<Δ(hᵢ,hₖ_{₂})< . . . <(hᵢ,hₖ_{_{K}})

where Δ(⋅) may be any appropriate distance metric and where hₖ_{ᵢ} represents the i^{th} hop neighbor for the node i.

A dissimilarity measure may be used to characterize the ranking between the latent representations of two nodes. Because the latent representations may be expressed as distributions, an asymmetric Kullback-Leibler divergence may be used. This helps handle directed graphs as well. The functions μ_{θ}(xᵢ) and Σ_{θ}(xᵢ) may be implemented as deep, feed-forward, non-linear neural networks, parameterized by θ.

$$\begin{matrix}Δ ( {h}_{i} , {h}_{j} ) = {D}_{KL} ( {𝒩}_{j} \vert \vert {𝒩}_{i} ) \\ = \frac{1}{2} [ tr ( {\sum }_{i}^{- 1} {\sum }_{j} ) + ( {μ}_{1} - {μ}_{j} ) {\sum }_{i}^{- 1} ( {μ}_{1} - , {μ}_{j} ) - log \frac{det ( {Σ}_{j} )}{det ( {Σ}_{i} )} ]\end{matrix}$$

where tr(⋅) is the trace of a matrix, where [symbol] ᵢ is the Gaussian embedding for entity i, μ is the mean, Σ is the covariance, and det(⋅) is the determinant of a matrix. An asymmetric Kullback-Leibler divergence can also be applied to an undirected graph, simply by processing both directions of the edges. In some embodiments, a symmetric dissimilarity measure, such as the Jensen-Shannon divergence or the expected likelihood, can be used.

To make full use of the seed alignments, a seed loss term may be employed as well:

[symbol]

_{cross}=D_{KL}(hᵢ,hⱼ),∀(i,j)ϵE_{seed}

where E_{seed} is a pre-aligned entity set from the training data. A loss term [symbol] _{cross} minimizes the dissimilarity between entities in E_{seed} and their counterparts. This may be accomplished by minimizing the Kullback-Leibler divergence between the Gaussian embeddings that represent the two entities.

The model loss can then be expressed as the sum of the structural loss and the seed loss: [symbol] = [symbol] _{structure}+ [symbol] _{cross}. By minimizing this loss function, the model can be optimized, bringing different knowledge graphs into alignment. Training data can be used that includes previously aligned entity pairs between the knowledge graphs. By propagating the representations of the entities across the graphs during the learning process, high-order similarities between all of the entities of the knowledge graphs can be determined.

Referring now to FIG. 4, a method of performing a knowledge graph task is shown. Block 402 receives multiple knowledge graphs, for example dealing with knowledge in related domains, but from sources or in formats that are not compatible with one another. For example, the knowledge graphs may deal with partially overlapping subject matter, but may be written in different languages. Different shades of meaning between the vocabularies of the two languages mean that a direct translation of terms may not effectively capture the true content of the foreign language knowledge graph.

To establish a common framework for the different knowledge graphs, block 300 can align the knowledge graphs, as described above. Block 404 then uses the aligned knowledge graphs to perform a task, taking advantage of the knowledge represented in all of the graphs.

For example, the task may include a question answering tasks. A user may pose a question, for example seeking information relating to a particular subject. Block 404 may use the aligned knowledge graphs to formulate a corresponding answer for the user's review.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

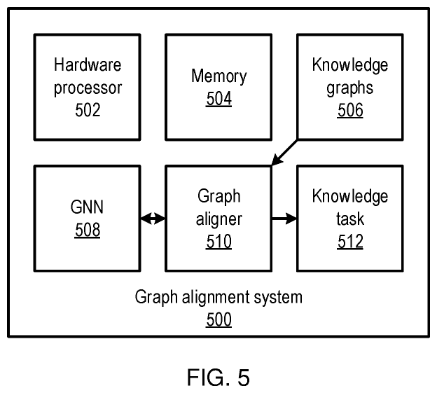

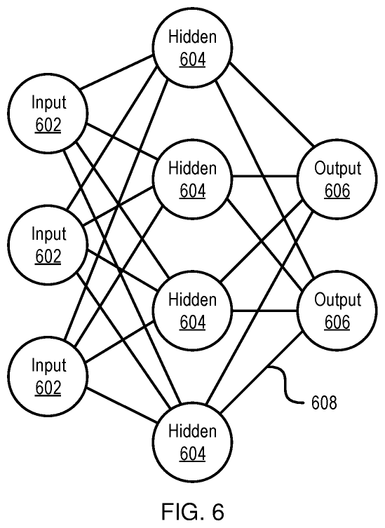

Referring now to FIG. 5, a graph alignment system 500 is shown, which can perform a knowledge task using multiple aligned knowledge graphs. The system 500 includes a hardware processor 502 and a memory 504, as well as multiple knowledge graphs 506 that may be stored in the memory. The knowledge graphs 506 may deal with the same subject matter, partially overlapping subject matter, or unrelated subject matter, and may have differences in how information is expressed or encoded.

A graph aligner 510 aligns the knowledge graphs 506, using representations of the entities in the knowledge graphs, along with the graph structure, to map the respective graphs onto one another in a latent space. A GNN 508 can be used to generate these representations. The GNN 508 may be implemented as a series of propagation layers. Within each propagation layer, from a given graph node's perspective, the node's representation is sent to its neighbors, including the μ and σ of the uncertainty distribution.

The resulting aligned knowledge graphs have entity representations that are consistent within each knowledge graph, due to intra-graph message passing, and that are consistent between the knowledge graphs, due to inter-graph message passing. The representations may be expressed using uncertainty distributions, thus capturing any uncertainty in the representations that may result from the alignment.

A knowledge task 512 uses the aligned knowledge graphs to perform a task, such as a question answering tasks. The combined set of representations from the knowledge graphs is used to leverage an expanded knowledge base. Thus, for example, foreign language knowledge bases, and knowledge bases from related fields, can be used to answer user questions with a greater depth and breadth.

Referring now to FIG. 6, a generalized diagram of a neural network is shown. The GNN 508 may be implemented as a specific form of an artificial neural network (ANN) that is configured to handle graph structures. ANN are characterized by the structure of the information processing system, which includes a large number of interconnected processing elements (called “neurons”) working in parallel to solve specific problems. ANNs may further be trained in-use, with learning that involves adjustments to weights that exist between the neurons. An ANN is configured for a specific application, such as natural language processing, pattern recognition, or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons 602 that provide information to one or more “hidden” neurons 604. Connections 608 between the input neurons 602 and hidden neurons 604 are weighted and these weighted inputs are then processed by the hidden neurons 604 according to some function in the hidden neurons 604, with weighted connections 608 between the layers. There may be any number of layers of hidden neurons 604, and as well as neurons that perform different functions. There exist different neural network structures as well, such as convolutional neural network, maxout network, etc. Finally, a set of output neurons 606 accepts and processes weighted input from the last set of hidden neurons 604.

This represents a “feed-forward” computation, where information propagates from input neurons 602 to the output neurons 606. Upon completion of a feed-forward computation, the output is compared to a desired output available from training data. The error relative to the training data is then processed in “feed-back” computation, where the hidden neurons 604 and input neurons 602 receive information regarding the error propagating backward from the output neurons 606. Once the backward error propagation has been completed, weight updates are performed, with the weighted connections 608 being updated to account for the received error. This represents just one variety of ANN.

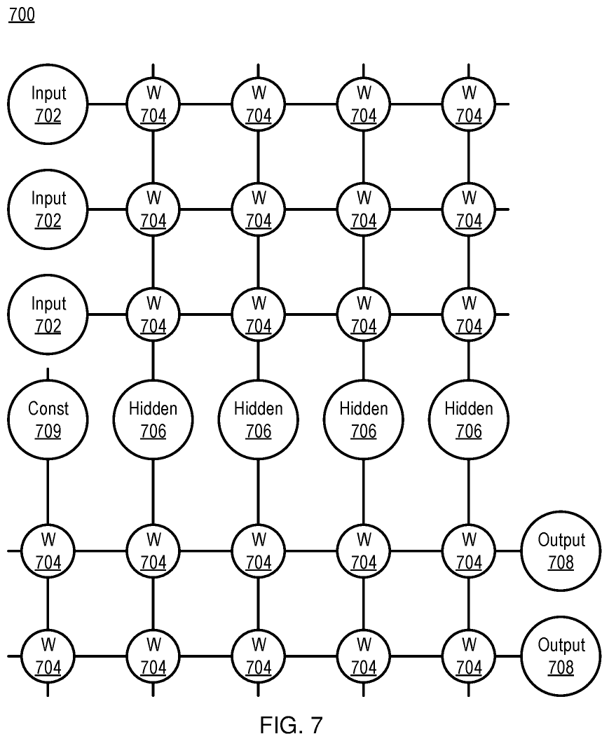

Referring now to FIG. 7, an ANN architecture 700 is shown. It should be understood that the present architecture is purely exemplary and that other architectures or types of neural network may be used instead. The ANN embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed and the weights can be omitted for more complicated forms of interconnection.

During feed-forward operation, a set of input neurons 702 each provide an input signal in parallel to a respective row of weights 704. The weights 704 each have a respective settable value, such that a weight output passes from the weight 704 to a respective hidden neuron 706 to represent the weighted input to the hidden neuron 706. In software embodiments, the weights 704 may simply be represented as coefficient values that are multiplied against the relevant signals. The signals from each weight adds column-wise and flows to a hidden neuron 706.

The hidden neurons 706 use the signals from the array of weights 704 to perform some calculation. The hidden neurons 706 then output a signal of their own to another array of weights 704. This array performs in the same way, with a column of weights 704 receiving a signal from their respective hidden neuron 706 to produce a weighted signal output that adds row-wise and is provided to the output neuron 708.

It should be understood that any number of these stages may be implemented, by interposing additional layers of arrays and hidden neurons 706. It should also be noted that some neurons may be constant neurons 709, which provide a constant output to the array. The constant neurons 709 can be present among the input neurons 702 and/or hidden neurons 706 and are only used during feed-forward operation.

During back propagation, the output neurons 708 provide a signal back across the array of weights 704. The output layer compares the generated network response to training data and computes an error. The error signal can be made proportional to the error value. In this example, a row of weights 704 receives a signal from a respective output neuron 708 in parallel and produces an output which adds column-wise to provide an input to hidden neurons 706. The hidden neurons 706 combine the weighted feedback signal with a derivative of its feed-forward calculation and stores an error value before outputting a feedback signal to its respective column of weights 704. This back propagation travels through the entire network 700 until all hidden neurons 706 and the input neurons 702 have stored an error value.

During weight updates, the stored error values are used to update the settable values of the weights 704. In this manner the weights 704 can be trained to adapt the neural network 700 to errors in its processing. It should be noted that the three modes of operation, feed forward, back propagation, and weight update, do not overlap with one another.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for performing a knowledge graph task, comprising:
aligning multiple knowledge graphs, comprising:
updating entity representations based on representations of neighboring entities within each knowledge graph;
updating entity representations based on representations of entities from different knowledge graphs; and
learning machine learning model parameters to align the multiple knowledge graphs, based on the updated entity representations; and
performing a knowledge graph task using the aligned multiple knowledge graphs.

2. The method of claim 1, wherein each entity representation is expressed as an uncertainty, including a mean and a covariance value.

3. The method of claim 1, wherein learning the machine learning model parameters includes minimizing a loss function that has a structural component and a seed component.

4. The method of claim 3, wherein the structural component maintains an internal structure of each knowledge graph during learning.

5. The method of claim 3, wherein the seed component maintains seed alignments during learning.

6. The method of claim 5, wherein maintaining seed alignments includes minimizing a distance between known entities in a set of training data and related entities of the multiple knowledge graphs, using a Kullback-Leibler divergence.

7. The method of claim 1, wherein updating entity representations based on representations of neighboring entities within each knowledge graph includes aggregating entity representations from node neighbors within each knowledge graph, and wherein updating entity representations based on representations of entities from different knowledge graphs includes a weighted sum of node representations from different graphs.

8. The method of claim 1, wherein the multiple knowledge graphs are in different respective languages.

9. The method of claim 1, wherein the knowledge graph task includes a natural language processing task.

10. The method of claim 9, wherein the knowledge graph task includes a question-answering task.

11. A system for performing a knowledge graph task, comprising:
a hardware processor;
a memory, configured to store a computer program product that, when executed by the hardware processor, implements:
graph alignment code that updates entity representations based on representations of neighboring entities within each knowledge graph of a set of multiple knowledge graphs, updates entity representations based on representations of entities from different knowledge graphs of the set of multiple knowledge graphs, and learns machine learning model parameters to align the knowledge graphs of the set of multiple knowledge graphs, based on the updated entity representations; and
knowledge graph task code that performs a knowledge graph task using the aligned knowledge graphs.

12. The system of claim 11, wherein each entity representation is expressed as an uncertainty, including a mean and a covariance value.

13. The system of claim 11, wherein the graph alignment code minimizes minimizing a loss function that has a structural component and a seed component.

14. The system of claim 13, wherein the structural component maintains an internal structure of each knowledge graph during learning.

15. The system of claim 13, wherein the seed component maintains seed alignments during learning.

16. The system of claim 15, wherein the graph alignment code minimizes a distance between known entities in a set of training data and related entities of the multiple knowledge graphs, using a Kullback-Leibler divergence.

17. The system of claim 11, wherein graph alignment code aggregates entity representations from node neighbors within each knowledge graph, and performs a weighted sum of node representations from different graphs.

18. The system of claim 11, wherein the multiple knowledge graphs are in different respective languages.

19. The system of claim 11, wherein the knowledge graph task includes a natural language processing task.

20. The system of claim 19, wherein the knowledge graph task includes a question-answering task.
